(19) United States
(12) Patent Application Publication
(10) Pub. No.: US 2018/0180725 A1
(43) Pub. Date: Jun. 28, 2018

(54) ULTRASONIC SENSOR DEVICE FOR ARRANGEMENT ON A CLADDING COMPONENT OF A VEHICLE

(71) Applicant: Robert Bosch GmbH, Stuttgart (DE)

(72) Inventors: David WEIDENFELDER, Leonberg (DE); Michael SCHUMANN, Stuttgart (DE); Rafael REISS, Stuttgart (DE)

(21) Appl. No.: 15/737,349

(22) PCT Filed: Jun. 9, 2016
(86) PCT No.: PCT/EP2016/063092

§ 371 Date: Dec. 18, 2017

(30) Foreign Application Priority Data
Jul. 6, 2015 (DE) 10 2015 212 599.8

(51) Int. Cl. G01S 7/521; G10K 11/00; G01S 15/93; B60R 19/48

(52) U.S. Cl. CPC G01S 7/521; G10K 11/004; G01S 2015/938; B60R 19/483; G01S 15/931

(57) ABSTRACT

An ultrasonic sensor apparatus for placement on a cladding component of a vehicle, encompassing an ultrasonic sensor and a holder. The holder encompasses a cap and a support. The support has a connecting portion by way of which the support is intermaterially joinable to the cladding component, and has a frame portion, an opening through which a vibrating element of the ultrasonic sensor extends being provided in the connecting portion. The cap preloads the ultrasonic sensor toward a coupling element, and is mounted detachably on the support using a latching connection. The cap delimits the receiving region on the side facing away from the connecting portion. The support is a hybrid component having a metal insert overmolded with plastic.

### BACKGROUND INFORMATION

The present invention relates to an ultrasonic sensor apparatus for placement on a cladding component of a vehicle, encompassing an ultrasonic sensor and a holder having a support and a cap. Further aspects of the present invention relate to a sensor assemblage encompassing such an ultrasonic sensor apparatus and a cladding component for a vehicle, and to a method for manufacture.

A plurality of sensors with which the environment of the vehicle is sensed are usually used in modern vehicles. Ultrasonic sensors are, in particular, sensors suitable for detecting the environment of the vehicle. Ultrasonic sensors emit an ultrasonic signal and detect ultrasonic echoes reflected from objects in the environment of the vehicle. The distance of the object can be inferred from the time that elapses between emission of the ultrasonic signal and reception of an ultrasonic echo, and from the known speed of sound.

Usual positions at which ultrasonic sensors are placed are the front and rear bumper of a motor vehicle. Generally, several ultrasonic sensors are disposed in one bumper, the ultrasonic sensors generally being disposed in recesses of the bumper so that a membrane of the ultrasonic sensors is not covered by the bumper and so that ultrasonic signals can be transmitted, and the ultrasonic echoes in turn received, without interference.

Also, some convention embodiments of ultrasonic sensors are disposed in concealed fashion on a cladding component of a vehicle, for example a bumper.

German Patent Application No. DE 10 2012 106 700 A1 describes an ultrasonic sensor assemblage for a motor vehicle, in which assemblage an ultrasonic sensor is disposed on the rear side of a cladding part of a vehicle. The assemblage encompasses a stiffening element, disposed around the membrane of the ultrasonic sensor, having a passthrough opening through which the membrane extends. Disposed between the rear side of the cladding part and the stiffening element is a plate-shaped intermediate element that is adhesively bonded to the cladding part and to the stiffening element. That region of the bumper which is excited by the ultrasonic sensor to vibrate is delimited with the aid of the stiffening element, so that undesired vibrations are not transferred to the remaining region of the cladding part.

German Patent Application No. DE 10 2010 049 818 A1 describes an assemblage having an external cladding element for a vehicle and having a sensor, in which the sensor is positioned in concealed fashion behind a partition. The sensor is pressed against the partition with a preload force via a holder connected to the external cladding element, so that it is held in position in frictional engagement with the partition. Provision is additionally made that the sensor is connected to the partition via a coupling layer, such that the coupling layer can be constituted by an adhesive coating of an adhesive element so that a reversible intermaterial connection is formed between the sensor and the partition. The holding apparatus is intermaterially connected to the external cladding element, for example by intermaterial connection using an adhesive element, or it is connected to the external cladding element by injection molding.

The existing art does not disclose any solution in which the holder for the ultrasonic sensor possesses sufficient rigidity, in which the connection between the holder and the cladding component can be guaranteed over the entire service life, critical regions are reliably sealed, and easy replacement of the ultrasonic sensor is enabled.

### SUMMARY

In accordance with the present invention, an ultrasonic sensor apparatus for placement on a cladding component of a vehicle is provided, encompassing an ultrasonic sensor and a holder having a support and a cap. The ultrasonic sensor encompasses a vibrating element. The support of the holder has a connecting portion by way of which the support is intermaterially joinable to the cladding component. The support furthermore has a frame portion that constitutes a receiving region for the ultrasonic sensor. An opening through which the vibrating element of the ultrasonic sensor extends is provided in the connecting portion.

The cap is mounted detachably on the support by way of a latching connection, the cap delimiting the receiving region on the side facing away from the connecting portion.

Provision is further made that the support is embodied as a hybrid component having a metal insert overmolded with plastic, the metal insert extending over both the connecting portion and the frame portion, and a first portion of the metal insert extending parallel to a surface by way of which the holder is joinable to the cladding component; and a second portion of the metal insert extending perpendicularly to the first portion. The plastic overmolding also extends both over the connecting portion and over the frame portion. The metal insert is preferably completely or almost completely overmolded with plastic; if applicable, small regions of the metal insert can be visible even after overmolding because of the retention of the metal insert in the mold used for overmolding. In particular, that surface of the hybrid component which is joinable to the cladding component is preferably completely overmolded with plastic.

The cladding component of the vehicle is, for example, a bumper, a bump strip, a mirror housing, a radiator grille, a door, a (lateral) sill, an underbody, a fender, or a lateral part.

Preferably the ultrasonic sensor apparatus is configured in such a way that a radial cavity is formed in the receiving region between the ultrasonic sensor and the frame portion of the support, and the cap has at least one centering rib that engages at least partly into the cavity. The centering rib is disposed and configured in such a way that it centers the ultrasonic sensor within the receiving region. For example, three centering ribs are disposed each at an angle of 120° to one another in order to center the ultrasonic sensor.

The ultrasonic sensor preferably has a membrane as a vibrating element. The membrane is, for example, of cup-shaped configuration, and extends through the opening in the connecting portion.

Preferably a sealing element is disposed between the vibrating element and the support in the region of the opening in the connecting portion. The sealing element is preferably produced from an elastomer; silicone, for example, is suitable as a material. The sealing element is configured in such a way that it seals the region between the ultrasonic sensor, cladding component, and holder, so that moisture cannot get to the coupling element between the ultrasonic sensor and the cladding component. It is preferably configured in such a way that it does not sit too tightly and thereby does not complicate assembly and disassembly operations. The sealing element can be configured in such a way that it engages partly into the radial cavity between the ultrasonic sensor and the frame portion of the support.

The cap is preferably configured to preload the ultrasonic sensor toward the coupling element. The cap preferably has a convexity in order to exert the preload force on the ultrasonic sensor. The convexity is disposed on the cap in such a way that the convexity serves as an elastic region of the cap, and the cap is connected to the ultrasonic sensor by way of the convexity. Alternatively, the cap can also have a mechanically resilient element that preloads the ultrasonic sensor toward the coupling element. Both elastomers and metallic bodies, for example springs, can be used in this context. These mechanically resilient elements can be separately placed in or connected to the cap, or are already connected to the cap upon manufacture of the latter; for example, they can be injection-molded into the cap. This facilitates assembly of the ultrasonic sensor.

Preferably the connecting portion of the support of the ultrasonic sensor apparatus has at least one welding rib on the side that is joinable to the cladding component. Preferably the welding rib is configured in such a way that it is disposed circumferentially around the opening in the connecting portion. This guarantees not only the necessary holding force but also sealing, so that moisture cannot penetrate at this joining point. Further nubs and ribs are preferably added in order to reduce vibrations in the cladding component; these are not relevant in terms of furnishing holding force, but do damp the cladding component in terms of its vibrations due to attachment to the rigid holder. It is thereby possible to ensure that vibration of the cladding component remains controllable over the entire temperature range. The additional ribs and nubs can furthermore be used to enable non-apparent attachment of the holder to the cladding component. The holder is very rigid as a result of its metal insert, so that the holder imposes its shape on the cladding component. If the temperature of the environment rises, the holder and the cladding component then expand to different degrees. This results in stresses that in turn cause the holder to become visibly apparent on the outer skin of the cladding component. Thanks to the ribs and nubs, the attachment of the holder to the cladding component is configured in such a way that the attachment is rigid only in a direction orthogonal to the cladding component but not in a parallel direction. Visibility is thus considerably reduced as compared with planar joining of the holder to the cladding component.

A coupling element that is disposed on the outward-facing side of the vibrating element is preferably used to transfer the vibrations of the ultrasonic sensor to a cladding component to which the support can be joined. The coupling element is preferably embodied as an adhesive layer or as an adhesive tape, the coupling element being configured to adhesively bond the vibrating element of the ultrasonic sensor to a region of the cladding component. The adhesive bonding is preferably accomplished in full-coverage fashion. Alternatively, it is preferred to embody the coupling element as an elastomer insert.

It is furthermore alternatively possible to embody the coupling element as a molded-on element on the ultrasonic sensor. The coupling element is thereby always connected to the ultrasonic sensor, and the probability of detachment is reduced.

Preferably the cladding element has a thinned-out region or is of thin configuration at least in the attachment region of the coupling element, a material thickness of less than 3 mm being regarded as “thin” in the case of polypropylene. The thinned-out region of the cladding component is configured, for example, in the form of a depression on the rear side of the cladding component. The result of the thinning is that the material thickness of the cladding component is reduced in the region at which the ultrasonic sensor is disposed, so that oscillations of the ultrasonic sensor can more easily be radiated and received again through the cladding component. The vibrations of the cladding component, and thus the radiation of the ultrasound, can be influenced by way of the shape of the thinned area, for example in order to produce a directional characteristic. For example, the thinned area is configured in the shape of a circle or an ellipse, and correspondingly adapted to the necessary radiation characteristic.

The coupling element embodied as an adhesive layer or adhesive tape is preferably protected, before being joined to the cladding component, with a protective layer that is removed only immediately before joining. The protective layer is embodied, for example, as a film.

For releasable mounting of the cap on the support, latching tabs that engage into corresponding openings on the cap are preferably provided on an outer side of the frame portion of the support. For example, three latching tabs and openings are respectively disposed for this purpose, in distributed fashion, over the circumference respectively of the frame portion and of the cap.

The support is embodied as a hybrid component made up of a metal insert that is overmolded with a plastic. The overmolding extends over both the connecting portion and the frame portion. The metal insert provides stiffening of the support. After joining of the holder to the cladding component, the first portion of the metal insert, which is located parallel to the surface to be joined to the cladding component, surrounds that region of the cladding component which is connected to the vibrating element of the ultrasonic sensor. Vibrations of the cladding component which are excited by the ultrasonic sensor outside the region delimited respectively by the holder and the support are reduced because of the rigidity of the support. In addition to stiffening of the holder by the metal insert, the elevated mass of the metal insert is advantageous in terms of reducing vibrations, since the mechanical impedance, i.e. the resistance to vibration, also increases with increasing mass and increasing rigidity. Both properties—mass and rigidity—thus produce a reduction in vibrations.

The metal insert can preferably be configured so that it exhibits stiffening ribs. This results in additional rigidity, with which vibrations are reduced. The stiffening ribs can be configured in the form of a cross member with which the two portions of the metal insert are connected to one another.

The metal insert is preferably produced from aluminum, brass, or stainless steel.

The plastic with which the metal insert is overmolded is preferably produced from a material that corresponds to the material of the cladding component. A variety of ultrasonic welding methods can thereby be used. A usual material for cladding components is polypropylene, optionally with various additives. The plastic can furthermore be modified, for example, by the addition of glass fibers or carbon fibers, or additives such as talc. Alternatively, a plastic differing from the material of the cladding component can also be selected, the plastic selected preferably being weldable to the material of the cladding component.

Because many cladding components of vehicles, for example the bumpers, are produced from polypropylene (PP), polypropylene or glass-fiber-reinforced polypropylene is particularly suitable as a plastic because the support, embodied as a hybrid component, can then be joined particularly effectively to the cladding component by intermaterial connection using a welding method. A suitable welding method is, for example, torsional ultrasonic welding, which is executed in particular in combination with the placement of at least one welding rib. Other methods, such as fusing, are furthermore also suitable for intermaterial connection.

Plastic, for example, is suitable as a material for the cap. In addition to the plastic already selected for overmolding the metal insert of the support, glass-fiber-reinforced polypropylene is especially suitable. Glass-fiber-reinforced polypropylene has a damping effect and at the same time exhibits high mechanical strength. Alternatively, the cap can also be manufactured as a hybrid component, for example with a molded-in spring or a molded-in elastomer to produce the preload force.

A sensor assemblage is also proposed, the sensor assemblage encompassing a cladding component for a vehicle as well as at least one of the above-described ultrasonic sensor apparatuses. Provision is also made that the ultrasonic sensor apparatus is joined to the rear side of the cladding component by intermaterial connection by way of the connecting portion of the support, and that the vibrating element of the ultrasonic sensor is connected by way of the coupling element to the cladding component. Connection is accomplished, for example, intermaterially by adhesive bonding, the adhesive bonding preferably being accomplished in full-coverage fashion.

A thinned-out region in the form of a depression is preferably disposed on the cladding component on a rear side of the cladding component, the vibrating element preferably being connected to the thinned-out region of the cladding component.

A welding method is preferably utilized for intermaterial joining of the support to the rear side of the cladding component, torsional ultrasonic welding being particularly suitable. Further intermaterial joining methods are, for example, adhesive bonding or fusion. If welding is selected as a joining method, it is accomplished in particular in combination with welding ribs disposed on the connecting portion.

The coupling element, which is embodied preferably in the form of an adhesive layer and particularly preferably in the form of adhesive tape, is preferably sealed with respect to the environment so that moisture cannot penetrate to the coupling element. It is therefore preferred that the coupling element be sealed with respect to the environment by way of the cladding component, the vibrating element, and the sealing element. The sealing element is preferably embodied rotationally symmetrically and inserted in the opening in the connecting portion of the support.

A further aspect of the present invention is provision of a method for manufacturing a sensor assemblage of this kind. In a first step of the method a holder, a cladding component, and an ultrasonic sensor are furnished. The holder encompasses a cap and a support, the support having a connecting portion and a frame portion, and the support being embodied as a hybrid component having a metal insert completely overmolded with plastic. The metal insert extends over both the connecting portion and the frame portion, a first portion of the metal insert extending parallel to a surface by way of which the support is joinable to the cladding component, and a second portion of the metal insert extending perpendicularly to the first portion.

This is followed, in a second step of the method, by an intermaterial joining of the connecting portion to a rear side of the cladding component. The intermaterial joining is preferably accomplished using a welding method, welding ribs and/or nubs preferably being disposed for this purpose on the connecting portion.

In a third step of the method, the ultrasonic sensor is inserted into the cap, the cap having a centering rib with which the ultrasonic sensor is positioned in the cap.

In a fourth step, a coupling element that is connected to the outward-facing side of a vibrating element of the ultrasonic sensor is furnished. This can be accomplished, for example, by application of an adhesive layer. It is furthermore possible for an adhesive tape already to be disposed on the vibrating element of the ultrasonic sensor, said tape being prepared for assembly, and thus furnished, by pulling off a protective film.

In a fifth step of the method, the cap is inserted with the ultrasonic sensor into a receiving region embodied in the support, a latching connection being produced between the cap and the support, and the vibrating element of the ultrasonic sensor extending through an opening in the connecting portion, and the coupling element preferably adjoining a thinned-out region of the cladding component and creating an intermaterial connection with the cladding component. The coupling element is sealed with respect to the environment by way of the vibrating element, the cladding component, and a sealing element disposed in the opening.

If it should be necessary later to replace the ultrasonic sensor of the sensor assemblage, this can be done by, in a first step, removing the cap, with the result that a radial cavity around the ultrasonic sensor is freely accessible. The ultrasonic sensor can be levered out with the aid of the cavity present in the radial directions. The coupling element, or the adhesive layer or adhesive tape, is thus preferably configured in such a way that the connection between the vibrating element and the cladding component can be undone. Any residues of the coupling element, or the adhesive or adhesive tape, are then removed from the thinned region, now accessible, of the cladding component. The holder is now ready for insertion of a new ultrasonic sensor.

A further aspect of the present invention relates to a vehicle that encompasses at least one of the sensor assemblages described.

With the example ultrasonic sensor apparatus and the example sensor assemblage described herein, an ultrasonic sensor can be respectively connected to a cladding component of a vehicle in such a way that it is not visibly apparent from the outside of the cladding component. In the preferred embodiments in which the holder is welded to the cladding components, that connection is furthermore particularly reliable, so that functionality of the sensor assemblage can be guaranteed for the entire service life of a vehicle. In addition, a mounting method that is resilient in a direction parallel to the cladding component is advantageously selected thanks to the provision of ribs and/or nubs. The holder thereby becomes considerably less visibly apparent on the outer side of the cladding component, as compared with full-coverage adhesive bonding.

The particularly good connection between the ultrasonic sensor apparatus and the cladding component is ensured by the support of the holder, which support is advantageously embodied as a hybrid component. The metal insert of the hybrid component imparts to the holder the rigidity and mass respectively necessary so that vibrations of the cladding component which occur are limited to the region that is adjacent to the membrane of the ultrasonic sensor. At the same time, the plastic with which the metal insert is overmolded permits a particularly durable connection, by way of welding, to cladding components that are usually produced from the same plastic.

A further advantage of the ultrasonic welding that is used is the compact design of the holder. Thanks to the large holding forces of the welding rib, the support of the holder can be implemented with a small diameter. With adhesive bonding methods, conversely, the holding force is, crucially, ensured over a substantially larger area of the adhesive bond. In addition, for adhesive bonding that area must be particularly thoroughly cleaned, which is not the case with welding. Cleaning during production can thus be limited to the area of the cladding component, and any paint splashes do not need to be removed because they do not negatively influence the weld.

A further advantage is to be seen in the fact that the two-part embodiment of the holder, in the form of a support and a cap, enables easy replacement of the ultrasonic sensor. After removal of the cap, which is connected to the support via a simple latching connection, the provision of the cavity allows the ultrasonic sensor to be easily levered off from the adhesive tape with which the vibrating element is coupled to the cladding component, and thereby detached.

In the assembled state, critical parts, such as the coupling element preferably embodied as an adhesive tape, are sealed with respect to the environment so that moisture cannot enter and impair the adhesive effect of the adhesive tape. The membrane of the ultrasonic sensor thus remains reliably coupled to the cladding component.

The ultrasonic sensor is furthermore preferably disposed in a region of the cladding component at which that component exhibits a depression or a thinned-out region. As a result, the ultrasonic sensor can particularly efficiently emit ultrasound through the cladding component and receive ultrasonic echoes again through the cladding component. This depression can be omitted in the case of thin cladding components.

The concealed placement allows the cladding component to be configured in esthetically pleasing fashion. Design freedom for these cladding components, for example bumpers, bump strips, mirror housing, radiator grille, doors, (lateral) sills, underbody, fenders, or lateral parts, is thereby advantageously expanded.

### BRIEF DESCRIPTION OF THE DRAWING

An exemplifying embodiment of the present invention is shown in the FIGURE and explained in further detail below.

FIG. 1 shows a sensor assemblage in which an ultrasonic sensor having a holder is disposed in concealed fashion on a cladding component of a vehicle.

### DETAILED DESCRIPTION OF EXAMPLE EMBODIMENTS

Example embodiments of the present invention is described below.

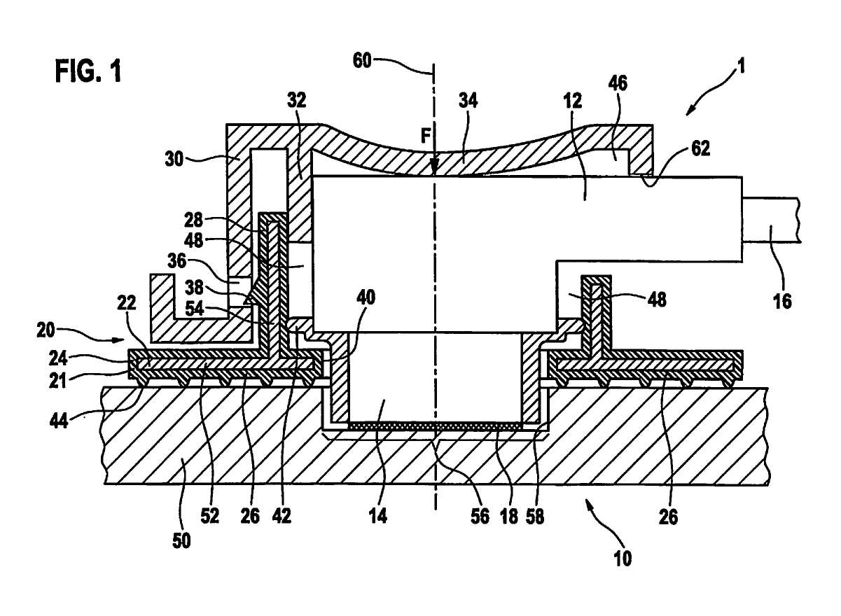

FIG. 1 depicts a sensor assemblage 10 that encompasses an ultrasonic sensor apparatus 1 and a cladding component 50 for a vehicle. Cladding component 50 is, for example, a bumper of a vehicle.

Ultrasonic sensor apparatus 1 encompasses an ultrasonic sensor 12 that can be mounted, with a holder 20, on the rear side of cladding component 50. In the situation depicted, holder 20 is already intermaterially joined to the rear side of cladding component 50. Holder 20 encompasses a support 21 as well as a cap 30, cap 30 being detachably mounted on support 21 via a latching connection.

Support 21 is embodied as a hybrid component and encompasses a metal insert 22 that is overmolded with a plastic 24. Plastic 24 completely surrounds metal insert 22. Metal insert 22 is produced, for example, from aluminum, brass, or stainless steel, and glass-fiber-reinforced polypropylene-GF is particularly suitable as plastic 24. Support 21 encompasses a connecting portion 26 and a frame portion 28. Connecting portion 26 is configured to respectively join holder 20 and support 21 intermaterially to cladding component 50. Frame portion 28 is configured in such a way that a receiving region 46, in which ultrasonic sensor 12 is received, is formed. Metal insert 22 also has two portions 52, 54, metal insert 22 extending over both connecting portion 26 and frame portion 28. A first portion 52 of metal insert 22 is disposed in connecting portion 26, first portion 52 of metal insert 22 extending respectively parallel to cladding component 50 and parallel to the surface to be joined to cladding component 50. A second portion 54 of metal insert 22 is disposed perpendicularly to first portion 52 in frame region 28.

In the embodiment depicted in FIG. 1, connecting portion 26 exhibits several welding ribs 44 on the surface that is to be joined to cladding component 50. At least connecting portion 26 of support 21 is embodied rotationally symmetrically with reference to an axis 60, so that welding ribs 44 are disposed annularly circumferentially in connecting portion 26. Nubs can also be placed in addition to welding ribs 44.

Connecting portion 26 furthermore has an opening 40 through which a vibrating element 14 of ultrasonic sensor 12 extends. In the embodiment depicted in the FIGURE, vibrating element 14 is embodied as a membrane of cup-shaped configuration. Ultrasonic sensor 12, or its vibrating element 14, is disposed on the rear side of cladding component 50 at a thinned-out region 56. Thinned-out region 56 is configured in the form of a depression 58 on the rear side of cladding component 50. A coupling element 18, which is placed between vibrating element 14 and thinned-out region 56 of cladding component 50, is provided for coupling of vibrating element 14 to cladding component 50 in thinned-out region 56. Coupling element 18 is preferably embodied as an adhesive tape or adhesive layer, and is configured in such a way that vibrations of vibrating element 14 are transferred to cladding component 50.

Coupling element 18 is sealed with respect to the environment via a sealing element 42 that is disposed in the region of opening 40 in support 21. Coupling element 18 is thus sealed with respect to the environment by cladding component 50, by vibrating element 14, and by sealing element 42. Sealing element 42 is embodied, for example, as an elastomer component.

The vibrations transferred to cladding component 50 respectively by ultrasonic sensor 12 or its vibrating element 14 remain limited to thinned-out region 56 located opposite vibrating element 14, since support 21, which is welded to cladding component 50, has a large mass and high rigidity. The rigidity and large mass are imparted to support 21 by its metal insert 22. Both first portion 52 that is located parallel to the surface to be joined to cladding component 50, and second portion 54 that is disposed perpendicularly thereto, contribute to the rigidity and mass of support 21.

Ultrasonic sensor 12 is on the one hand, as described, intermaterially connected to cladding component 50 via coupling element 18 that is embodied, for example, as an adhesive tape. In addition, a frictionally engaged connection between ultrasonic sensor 12 and cladding component 50 is produced via holder 20. For this, cap 30 of holder 20 exerts a preload force F in an axial direction (see axis 60) on ultrasonic sensor 12. In order to generate the preload force, cap 30 has a convexity 34 that represents an elastic region of cap 30. Cap 30 presses with its convexity 34 on ultrasonic sensor 12 in an axial direction, and thereby exerts a preload force on sensor 12 toward coupling element 18 and toward cladding component 50.

In the embodiment depicted in FIG. 1, support 21 has latching tabs 38 that engage into corresponding openings 36 of cap 30 in order to create a detachable latching connection between cap 30 and support 21. Both support 21 and cap 30 are embodied substantially rotationally symmetrically with respect to axis 60; for example, three latching tabs 38 and three corresponding openings 36 are disposed in distributed fashion respectively on the periphery of cap 30 and on frame portion 28 of support 21.

Ultrasonic sensor 12 has a connecting lead 16 through which control can be applied to ultrasonic sensor 12. Cap 30 has a corresponding cutout 62 in order to guide connecting lead 16 out.

For installation of sensor assemblage 10, in a first step support 21 is joined to cladding component 50 with the aid of welding ribs 44 using a welding method, for example torsional ultrasonic welding. In a second step ultrasonic sensor 12 is inserted into cap 30, the exact position of ultrasonic sensor 12 being defined by a centering rib 32. If coupling element 18 is embodied, for example, as an adhesive tape, a protective film that may be present is then removed from the adhesive tape.

In a third step, cap 30 together with ultrasonic sensor 12 is placed onto support 21. In this process, ultrasonic sensor 12 is introduced into receiving region 46, and vibrating element 14 of ultrasonic sensor 12 is passed through opening 40 so that vibrating element 14, or coupling element 18 disposed on vibrating element 14, can become connected in adhesively bonded fashion to thinned-out region 56 of cladding component 50. Cap 30 is secured on support 21 by the latching connections provided by latching tabs 38 and openings 36.

Upon insertion of ultrasonic sensor 12, centering rib 32 engages partly into receiving region 46 and into a radial cavity 48 between ultrasonic sensor 12 and edge portion 28 of support 21.

If ultrasonic sensor 12 needs to be replaced, for example in the event of a defect in ultrasonic sensor 12, then in a first step cap 30 is removed from support 21. The radial cavity 48 present between ultrasonic sensor 12 and edge portion 28 of support 21 then allows ultrasonic sensor 12 to be detached from coupling element 18, embodied as an adhesive tape, by levering ultrasonic sensor 12 off. This cavity 48 is easily accessible after the removal of cap 30. Once ultrasonic sensor 12 has been levered off, residues of coupling element 18, i.e. residues of adhesive or of adhesive tape, can be removed from cladding component 50 or from thinned-out region 56. Holder 20 is now ready for the insertion of a new ultrasonic sensor 12.

The present invention is not limited to the exemplifying embodiments described here and to the aspects emphasized therein. To the contrary, a plurality of modifications that are within the competence of one skilled in the art are possible within the context of the present invention.

1-11. (canceled)

12. An ultrasonic sensor apparatus for placement on a cladding component of a vehicle, comprising:
an ultrasonic sensor including a vibrating element; and
a holder having a support and a cap, the support having a connecting portion by way of which the support is intermaterially joinable to the cladding component, and a frame portion that constitutes a receiving region for the ultrasonic sensor, the connecting portion having an opening through which the vibrating element of the ultrasonic sensor extends being provided in the connecting portion, the cap being mounted detachably on the support by way of a latching connection, the cap delimiting the receiving region on a side facing away from the connecting portion, wherein the support is embodied as a hybrid component having a metal insert overmolded with plastic, the metal insert extending over both the connecting portion and the frame portion, a first portion of the metal insert extending parallel to a surface by way of which the support being joinable to the cladding component, and a second portion of the metal insert extends perpendicularly to the first portion.

13. The ultrasonic sensor apparatus as recited in claim 12, wherein in the receiving region, a radial cavity is formed between the ultrasonic sensor and the frame portion of the support, and the cap has a centering rib that engages at least partly into the cavity.

14. The ultrasonic sensor apparatus as recited in claim 12, wherein a sealing element is disposed between the vibrating element and the support in a region of the opening in the connecting portion.

15. The ultrasonic sensor apparatus as recited in claim 12, wherein the cap is configured to preload the ultrasonic sensor toward the coupling element.

16. The ultrasonic sensor apparatus as recited in claim 12, wherein the connecting portion has at least one of a welding rib and nubs, the at least one of the welding rib and nubs being on a side of the connecting portion that is joinable to the cladding component.

17. The ultrasonic sensor apparatus as recited in claim 12, wherein a coupling element is disposed on an outward-facing side of the vibrating element.

18. The ultrasonic sensor apparatus as recited in claim 12, wherein for releasable mounting of the cap on the support, latching tabs that engage into corresponding openings on the cap are provided on an outer side of the frame portion of the support.

19. A sensor assemblage, comprising:
a cladding component for a vehicle; and
an ultrasonic sensor apparatus for placement on the cladding component, the ultrasonic sensor apparatus including an ultrasonic sensor including a vibrating element, and a holder having a support and a cap, the support having a connecting portion by way of which the support is intermaterially joinable to the cladding component, and a frame portion that constitutes a receiving region for the ultrasonic sensor, the connecting portion having an opening through which the vibrating element of the ultrasonic sensor extends being provided in the connecting portion, the cap being mounted detachably on the support by way of a latching connection, the cap delimiting the receiving region on a side facing away from the connecting portion, wherein the support is embodied as a hybrid component having a metal insert overmolded with plastic, the metal insert extending over both the connecting portion and the frame portion, a first portion of the metal insert extending parallel to a surface by way of which the support being joinable to the cladding component, and a second portion of the metal insert extends perpendicularly to the first portion;
wherein the ultrasonic sensor apparatus is intermaterially joined to the rear side of the cladding component by way of the connecting portion of the support.

20. The sensor assemblage as recited in claim 19, wherein the vibrating element of the ultrasonic sensor is connected by way of the a coupling element to the cladding component, the coupling element being sealed with respect to the environment by way of the cladding component, the vibrating element, and a sealing element, so that moisture cannot enter.

21. A method for manufacturing a sensor assemblage, the method comprising:
a. furnishing a cladding component, a cap, a support and an ultrasonic sensor;
b. intermaterially joining a connecting portion of the support to a rear side of the cladding component;
c. inserting the ultrasonic sensor into the cap, the ultrasonic sensor being positioned by way of at least one centering rib of the cap;
d. furnishing a coupling element that is connected to the outward-facing side of a vibrating element of the ultrasonic sensor; and
e. inserting the cap with the ultrasonic sensor into a receiving region embodied in the support, a latching connection being produced between the cap and the support, and the vibrating element of the ultrasonic sensor extending through an opening in the connecting portion, and the coupling element adjoining the cladding component and creating an intermaterial connection.

22. A vehicle having a sensor assemblage, the sensor assemblage comprising:
a cladding component for the vehicle; and
an ultrasonic sensor apparatus for placement on the cladding component, the ultrasonic sensor apparatus including an ultrasonic sensor including a vibrating element, and a holder having a support and a cap, the support having a connecting portion by way of which the support is intermaterially joinable to the cladding component, and a frame portion that constitutes a receiving region for the ultrasonic sensor, the connecting portion having an opening through which the vibrating element of the ultrasonic sensor extends being provided in the connecting portion, the cap being mounted detachably on the support by way of a latching connection, the cap delimiting the receiving region on a side facing away from the connecting portion, wherein the support is embodied as a hybrid component having a metal insert overmolded with plastic, the metal insert extending over both the connecting portion and the frame portion, a first portion of the metal insert extending parallel to a surface by way of which the support being joinable to the cladding component, and a second portion of the metal insert extends perpendicularly to the first portion;
wherein the ultrasonic sensor apparatus is intermaterially joined to the rear side of the cladding component by way of the connecting portion of the support.
